(19) United States
(12) Patent Application Publication
(10) Pub. No.: US 2022/0065198 A1
(43) Pub. Date: Mar. 3, 2022

(54) FUEL INJECTING NOZZLE

(71) Applicant: ZAMA JAPAN CO. LTD., Iwate (JP)

(72) Inventors: Daisuke Suzuki, Iwate (JP); Takumi Takahashi, Iwate (JP); Naoya Wada, Iwate (JP); Giovanni Leccese, Iwate (JP); Satomi Ochiyasu, Iwate (JP); Haruki Kudo, Iwate (JP); Toshiyuki Kuyo, Iwate (JP)

(21) Appl. No.: 17/464,884

(22) Filed: Sep. 2, 2021

(30) Foreign Application Priority Data
Sep. 2, 2020 (JP) 2020-147832

(51) Int. Cl. F02M 19/04

(52) U.S. Cl. CPC F02M 19/04

(57) ABSTRACT

To provide a fuel injection nozzle that not only enables adjustment of a flow rate, but also causes contaminants and gum to pass through to reduce an effect on the flow rate. A fuel injection nozzle having a flat portion on an outer peripheral face of a needle is disclosed. The fuel injection nozzle opens at a predetermined angle, and, by the needle moving in an axial direction in an inner periphery of an injection hole, gaps are formed between the outer peripheral face of the needle and an inner peripheral face of the injection hole of a nozzle body. Adjustment to a desired fuel injection flow rate is possible by setting an outer diameter of the needle, a distance from the seat portion to a starting position of the flat portion on the outer peripheral face of the needle, and an incline angle of the flat portion.

### CROSS-REFERENCE TO RELATED APPLICATION

The subject application claims the benefit of Japanese Patent Application No. 2020-147832, filed Sep. 2, 2020, which is incorporated herein by reference in its entirety.

### TECHNICAL FIELD

The present invention relates to a fuel injection nozzle that injects fuel into an air intake passage in a carburetor of an engine.

### BACKGROUND

Conventionally, as illustrated in FIG. 10 and FIG. 11, a fuel injection nozzle is known that is provided with: a nozzle body 5 that has a conical injection hole 2, made to a prescribed length at whose distal end is formed a nozzle hole 1 that injects fuel into an air intake passage of a carburetor, and, on a proximal-end side of the nozzle hole 1 and in continuation with a fuel channel 3, a seat face 4 of a truncated-cone shape; and a conical needle 7. The conical needle 7 having a seat portion 6, which opens and closes the fuel channel 3 by moving away from or against the seat face 4. The conical needle 7 housed in the nozzle body 5 so the conical needle 7 may be made to reciprocate in an axial direction by, for example, a well-known carburetor. Such a fuel injection nozzle is presented in, for example, JP S52-68719 U.

Additionally, the conventional fuel injection nozzle causes the needle 7 to undergo reciprocating motion, to spray, from the spray hole 1 into, for example, an air intake passage 10, a prescribed amount of fuel, through adjusting the total amount of a gap 9 that is formed between the inner peripheral surface of the injecting hole 2 of the nozzle body 5 and an inclined outer peripheral surface 8 of the needle 7, or to stop spraying at an inner peripheral face of the injection hole 2 of the nozzle body 5 in order to inject a predetermined quantity of fuel from the nozzle hole 1 to, for example, an air intake passage 10. Alternatively, the conventional fuel injection nozzle seats the seat portion 6 of the needle 7 on the seat surface 4 of the nozzle body 5 to stop fuel injection.

However, as illustrated in FIG. 10, in the conventional fuel injection nozzle, the needle 7 is conical, the injection hole 2 that is formed in the nozzle body 5 is a cylindrical cavity, and the ring-shaped gap 9 formed between the outer peripheral surface 8 of the needle 7 and the inner peripheral surface of the injection hole 2 has the same width at any periphery. Moreover, in changing the fuel injection quantity by moving the needle 7 in the axial direction, a flow rate is adjusted by conical angle changes in this situation as well, although the gap 9 itself increases, as illustrated in FIG. 11, the gap 9 has the same width across the entire periphery. A problem is that even when the fuel injection flow rate increases and an area of an arc shape formed by the gap 9 increases, adjusting the fuel flow rate is difficult because the change is small in the increase amount of the gap 9 itself.

Furthermore, in the conventional fuel injection apparatus, at a time of assembly, the seat portion 6 of the needle 7 is used to perform seating on the seat face 4 of the injection hole 2 in the nozzle body 5 to create a state wherein no fuel flows at a time of complete closure. However, at this time, because diameters of the injection hole 2 and the inclined outer peripheral surface 8 of the needle 7 are small and a clearance from the inner peripheral face of the injection hole 2 is small, a problem is also that contaminants and gum in the fuel may clog the fuel injection. Moreover, due to, for example, the needle 7 and the injection hole 2 being designed concentrically, a problem is had wherein a distal end of the needle 7 becomes damaged at the time of assembly.

### SUMMARY

Embodiments of the present invention attempt to solve the problems in the conventional fuel injection nozzle, described above, and objects thereof are as follows: to enable easy adjustment of a flow rate to achieve the same opening area as the conventional product to enable easy adjustment so a desired fuel injection flow rate is obtained relative to a feed amount of a needle; and to cause contaminants and gum to pass through to reduce their effect on the flow rate.

The disclosure includes a fuel injection nozzle made to solve the above problems. The fuel injection nozzle, provided with: a cylindrical nozzle body that is continuous with an injection hole, made of a cylindrical cavity having a predetermined length at whose distal end is formed a nozzle hole that injects fuel into an air intake passage of a carburetor in an engine, and a seat face of a truncated-cone shape forming a fuel channel on a proximal-end side of the nozzle hole; and a cylindrical needle that has a seat portion of a truncated-cone shape, which opens and closes the fuel channel by sitting away from or against the seat face, and is housed so as to enable reciprocating motion in an axial direction in the nozzle body—a flat portion being formed, on an outer peripheral surface of the needle, that opens at a prescribed angle from the seat portion to a distal-end face, and, by the needle moving in the axial direction in an inner periphery of the injection hole, a gap amount formed between the outer peripheral face of the needle and an inner peripheral face of the injection hole of the nozzle body being adjusted so a predetermined quantity of fuel is injected to the air intake passage, or fuel injection being stopped by seating the seat portion of the needle against the seat surface of the nozzle body, wherein: adjustment to a desired fuel injection flow rate may be achieved by setting an outer diameter of the needle, a distance from the seat portion to a starting position of a flat portion formed on the outer peripheral surface of the needle, and an incline angle of the flat portion.

In an embodiment of the present invention, the flat portion formed on the outer peripheral surface of the needle starts a prescribed distance away from the tip. As such, simply inserting the cylindrical base portion of the needle into the cylindrical injection hole easily and reliably forms a concentric state between an axial center of the needle and an axial center of the injection hole of the nozzle body. This enables smooth reciprocation of the needle in the axial direction and facilitates assembly such that there is not concern of accidentally damaging a distal end of the needle at a time of assembly.

An embodiment of the present invention provides a fuel injecting needle that enables easy adjustment so as to have the same opening area as a conventional product. Moreover, by setting the outer diameter of the needle, the distance from the seat portion to the starting position of the flat portion formed on the outer peripheral surface of the needle, and the inclination angle of the flat portion, easy adjustment is enabled so a desired fuel injection rate relative to a feed amount of the needle is obtained. Moreover, a fuel injection nozzle can be provided that causes contaminants and gum of a large diameter to pass through, reducing an effect on the flow rate, and does not damage the distal end of the needle when, at a time of assembly, the needle is inserted in a prescribed position of the injection hole.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a longitudinal sectional view illustrating a main portion of an embodiment, illustrating a state wherein a seat portion of a needle is seated on a seat face of a nozzle body to stop fuel injection.

FIG. 2 is a partial perspective view of the needle in the embodiment illustrated in FIG. 1.

FIG. 3 is a cross-sectional view at line A-A in FIG. 1.

FIG. 4 is a relationship diagram illustrating measurements in a relationship between a feed amount of a needle relative to a nozzle body and a gap for a conventional fuel injection nozzle and a fuel injection nozzle in the embodiment illustrated in FIG. 1.

FIG. 5 is a front view of the needle in the embodiment illustrated in FIG. 1.

FIG. 6 is a diagram of the relationship between the feed amount and the opening area in the embodiment illustrated in FIG. 1.

FIG. 7 is a diagram of the relationship between the feed amount and the opening area for the embodiment illustrated in FIG. 1 and a conventional example.

FIG. 8 is a diagram of the relationship between the feed amount and the opening area for the embodiment illustrated in FIG. 1 and a conventional example, using another feed amount.

FIG. 9 is a diagram illustrating the relationship between the feed amount and the opening area for the embodiment illustrated in FIG. 1 and a conventional example, using yet another feed amount.

FIG. 10 is a longitudinal sectional view illustrating a conventional example.

FIG. 11 is a cross-sectional view at line B-B in FIG. 10.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

An embodiment of a fuel injection nozzle is described below based on the included drawings.

Note that a mechanism of reciprocating motion of a needle that is used in a fuel injecting nozzle and a method of using the fuel injection nozzle may be like a conventional fuel injection apparatus, and detailed description thereof is omitted.

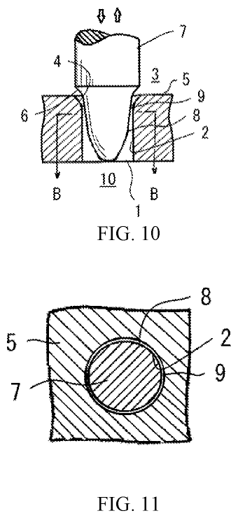

Furthermore, components identical or similar to the conventional example illustrated in FIG. 10 and FIG. 11 are described using the same reference signs.

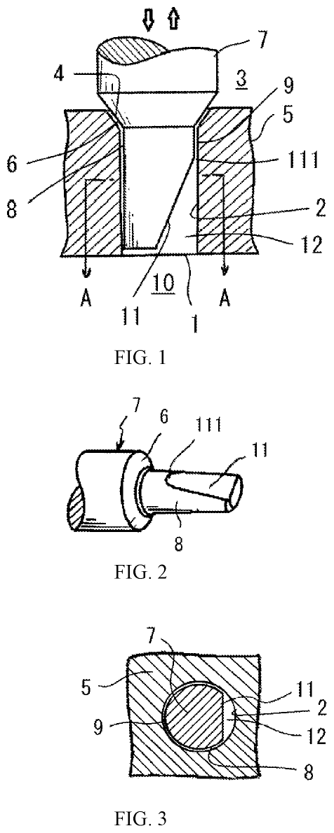

FIG. 1 to FIG. 3 illustrate a main portion of an embodiment of the fuel injection nozzle. This is fundamentally similar to the conventional example illustrated in FIG. 10 and FIG. 11 and is provided with a nozzle body 5 that has a cylindrical injection hole 2 made of a cavity having a predetermined length and, formed at its distal end, a nozzle hole 1 for injecting fuel to an air intake passage 10 of a carburetor in an engine. On a proximal-end, the injection hole 2 includes a seat face 4 having a truncated-cone shape that is continuous with a fuel channel 3. A needle 7 that has a seat portion 6, which opens and closes the fuel channel 3 by sitting away from or against the seat surface 4, is housed in the nozzle body 5.

Additionally, in an embodiment that is illustrated in FIG. 6, the needle 7 as depicted in FIG. 6 has a circular column shape that has a diameter D that can fit, with a gap 9, into an injection hole 2 and is continuous with the seat portion 6, which has a truncated-cone shape, and forms, on an outer peripheral surface 8 thereof, a flat portion 11 that opens at a prescribed angle θ at a distal-end direction from a starting position 111, which is a predetermined distance S away from the seat portion 6.

In the present embodiment that has a structure having such a configuration, the flat portion 11 formed on the outer peripheral surface 8 of the needle 7 starts a prescribed distance away from the seat portion 6 in the distal-end direction. As such, simply inserting the cylindrical base portion of the needle 7 into the cylindrical injection hole 2 easily and reliably forms a concentric state between an axial center of the needle 7 and an axial center of the injection hole 2 of the nozzle body 5. This enables smooth reciprocation of the needle 7 in an axial direction and facilitates assembly such that there may not be concern about damaging the tip of the needle 7 at a time of assembly.

Furthermore, an example embodiment injects a predetermined quantity of fuel to the air intake passage 10 by adjusting gaps 9, 12 formed relative to an inner peripheral face of the injection hole 2 of the nozzle body 5. This may be done by moving the needle 7 in an opening direction (upward or downward in FIG. 1) along the axial direction from a state wherein the seat portion 6 of the needle 7 is seated on the seat face 4 of the nozzle body 5 illustrated in FIG. 1 to stop fuel injection.

At this time, in the present embodiment, as illustrated in FIG. 3, the gap 9 between the cylindrical portion of the needle 7 and the injection hole 2 in the nozzle body 5 may be formed at substantially the same width as the conventional gap 9 illustrated in FIG. 9, but a width of the arc-shaped gap 12 relative to the flat portion 11 may be greater than the width of the conventional gap 9. This enables contaminants and gum having a particle a size that prevented the contaminants and gum from passing through the gap 9 formed by the conventional conical needle 7 illustrated in FIG. 9 and FIG. 10 and FIG. 11 to pass through such that a flow rate may be affected less.

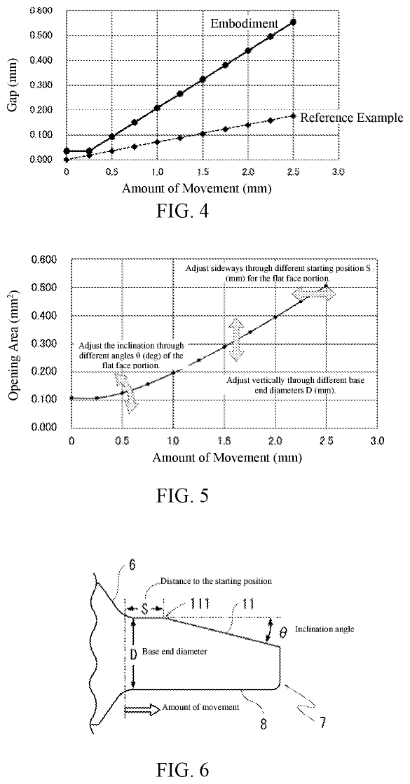

Furthermore, FIG. 4 illustrates measurements in a relationship between a feed amount of the needle 7 relative to the nozzle body 5 and an opening area for the conventional fuel injection nozzle using the conical needle 7 illustrated in FIG. 10 and FIG. 11 and the fuel injection nozzle in the example embodiment. The diagram confirms that an amount of change in an opening curve of the conventional example (the illustrated dashed line) is gradual compared to an amount of change in an opening curve of the present embodiment (the illustrated solid line). For example, when a measurement value of a gap in the opening curve of the conventional example (the illustrated dashed line) is 0.1 mm, a measurement value of the gap in the opening curve of the present embodiment is indicated as no less than 0.3 mm, which is three times as large. It can be confirmed from this as well that the present embodiment enables contaminants of a particle size having a size that prevented them from passing through the gap 9, 12 formed by the conventional conical needle 7 to pass through.

Furthermore, FIG. 5 illustrates a diagram of the relationship between the feed amount of the needle 7 relative to the nozzle body 5 and the opening area for the fuel injection nozzle in the present embodiment. Regarding the curve of the opening area relative to the feed amount, a slope direction may be adjusted by different parameters for the incline angle θ (deg) of the flat portion 11 illustrated in FIG. 6, a vertical direction may be adjusted by different parameters for the proximal-end diameter D (mm) of the needle 7, and a horizontal direction may be adjusted by different parameters for the starting position S (mm) of the flat portion 11 on the needle 7.

Therefore, the nozzle for fuel injection in the present embodiment may, by changing these parameters, set a fuel injection nozzle adjusted to have predetermined changes in the opening area relative to predetermined feed amounts based on the relationship between the feed amount of the needle 7 relative to the nozzle body 5 and the opening area.

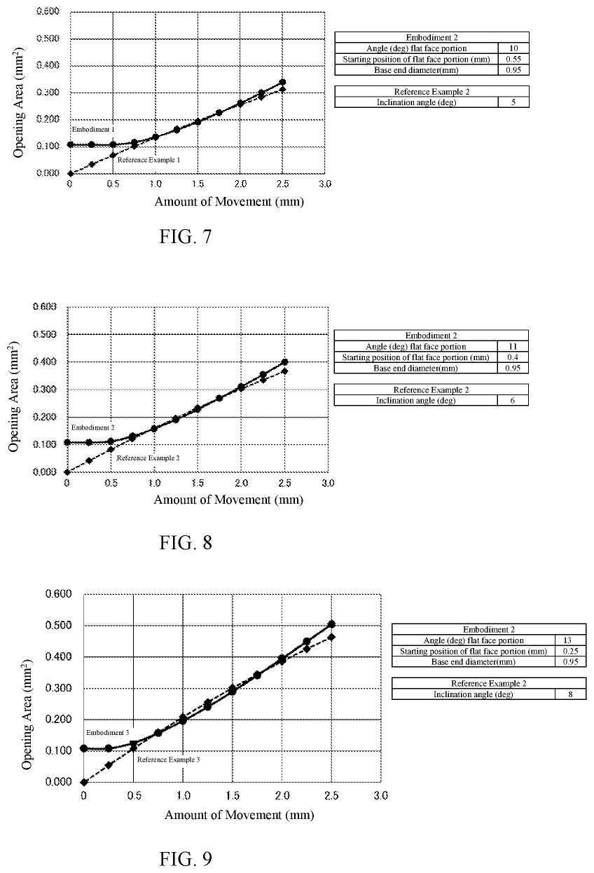

FIG. 7 to FIG. 9 each illustrate measurement lines (illustrated as dashed lines) of the relationship between the feed amount of the needle 7 relative to the nozzle body 5 and the opening area of the gap for comparative examples 1 to 3, wherein an angle of an inclined face of the conventional conical needle 7 illustrated in FIG. 10 and FIG. 11 is 5, 6, and 8 (deg), and measurement lines (illustrated as solid lines) of examples 1 to 3, wherein the parameters for the incline angle θ (deg) of the flat portion 11, the proximal-end diameter D (mm) of the needle 7, and the starting position S (mm) of the flat portion 11 on the needle 7 illustrated in FIG. 6 are set such that, in an embodiment of the present invention, measurement lines (illustrated as solid lines) of the relationship between the feed amount and the opening area are obtained that approximate the measurement lines (illustrated as dashed lines) of the relationship between the feed amount and the opening area for comparative examples 1 to 3.

In an example embodiment, the characteristics may be set to approximate the change in opening area, in respect to the amount of movement of a conventional circular conical fuel injecting nozzle, through adjusting the inclination angle of the flat portion 11 depicted in FIG. 6. As such, by adjusting the incline angle θ of the flat portion 11, the base end diameter D of the needle 7, and the distance S to the starting position 111 of the flat portion 11 on the needle 7 illustrated in FIG. 6, an embodiment may be set to characteristics that approximate the change in the opening area relative to the feed amount in the conventional conical fuel injection nozzle. This demonstrates that an embodiment may replace an existing conical fuel injection nozzle while retaining the same opening area. An economic benefit may also be had because new design work may be reduced or eliminated when implementing embodiments of the present invention.

Furthermore, machining may be easier compared to the existing conical fuel injection nozzle—cut angles/positions are easily adjusted, measurement is easy, variation is low, and dimensional precision can be achieved. As such, a carburetor that may be inexpensive and performs well may be supplied.

Note that while the present embodiment was explained for a spray-type carburetor, application is possible in the same way for a fuel injecting valve that uses injection wherein fuel is sprayed into the cylinder of the engine, for.

### REFERENCE SYMBOLS

1: Spray Hole

2: Injecting Hole

3: Fuel Flow Path

4: Seat Surface

5: Nozzle Body

6: Seat Portion

7: Needle

8: Outer Peripheral Surface

9: Gap

10: Air Intake Passage

11: Flat Face Portion

12: Gap

111: Starting Position.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A fuel injection nozzle, comprising:
a cylindrical nozzle body that is continuous with an injection hole, made of a cylindrical cavity having a prescribed length at whose distal end is formed a nozzle hole that injects fuel to an air intake passage of a carburetor in an engine, and a seat face of a truncated-cone shape forming a fuel channel on a proximal-end side of the nozzle hole; and
a cylindrical needle that has a seat portion of a truncated-cone shape, which opens and closes the fuel channel by sitting away from or against the seat face, and is housed so as to be able to reciprocate in an axial direction in the cylindrical nozzle body, a flat portion being formed, on an outer peripheral face of the cylindrical needle, that opens at a predetermined angle from the seat portion to a distal-end face, and, by the cylindrical needle moving in the axial direction in an inner periphery of the injection hole, a gap amount formed between the outer peripheral face of the cylindrical needle and an inner peripheral face of the injection hole of the cylindrical nozzle body being adjusted so a predetermined quantity of fuel is injected to the air intake passage, or fuel injection being stopped by seating the seat portion of the cylindrical needle on the seat face of the cylindrical nozzle body,
wherein adjustment to a desired fuel injection flow rate is possible by setting an outer diameter of the cylindrical needle, a distance from the seat portion to a starting position of the flat portion formed on the outer peripheral face of the cylindrical needle, and an incline angle of the flat portion.

2. The fuel injection nozzle according to claim 1, wherein the flat portion formed on the outer peripheral face of the cylindrical needle starts a predetermined distance away, in a distal-end direction, from the seat portion.
